(19) United States
(12) Patent Application Publication
(10) Pub. No.: US 2015/0154103 A1
(43) Pub. Date: Jun. 4, 2015

(54) METHOD AND APPARATUS FOR MEASURING SOFTWARE PERFORMANCE

(71) Applicant: SAMSUNG ELECTRONICS CO., LTD., Suwon-si (KR)

(72) Inventors: Seung-won LEE, Hwaseong-si (KR); Chae-seok IM, Yongin-si (KR); Do-hyung KIM, Hwaseong-si (KR); Tai-Song JIN, Seoul (KR)

(73) Assignee: SAMSUNG ELECTRONICS CO., LTD., Suwon-si (KR)

(21) Appl. No.: 14/554,994

(22) Filed: Nov. 26, 2014

(30) Foreign Application Priority Data
Nov. 29, 2013 (KR) 10-2013-0147522

(51) Int. Cl. G06F 11/36; G06F 9/44

(52) U.S. Cl. CPC G06F 11/3688; G06F 8/70

(57) ABSTRACT

A method of measuring software performance includes inserting a performance measurement code into a source code, stalling a target system, on which the code is executed by a processor, and a performance counter based on the performance measurement code, transmitting performance data corresponding to a stalled time point when the target system and the performance counter are stalled to a host system configured to store the performance data corresponding to the stalled time point, and resuming execution of the source code by the target system and of the performance counter while the performance data is transmitted and stored.

### CROSS-REFERENCE TO RELATED APPLICATION

This application claims priority from Korean Patent Application No. 10-2013-0147522, filed on Nov. 29, 2013, in the Korean Intellectual Property Office, the disclosure of which is incorporated herein in its entirety by reference.

### BACKGROUND

1. Field

Methods and apparatuses consistent with exemplary embodiments relate to measuring software performance, and more particularly, to measuring the performance of each function of software.

2. Description of the Related Art

A process of analyzing software performance generally includes collecting information during execution of software, storing and transmitting the collected information, and analyzing the transmitted information. Although storing and transmitting the collected information without loss and determining an intuitive analysis result is important, the information collection method is also important for obtaining reliable measurement information. Generally, a method of collecting information may be broadly classified into a method of tracing a source operation, a method of tracing an execution file operation, and a sampling method.

In the source operation tracing method, a measurement code needed for tracing is inserted into software so as to extract information during software execution. When the software is executed, only a routine into which the measurement code has been inserted is executed, and thus, the performance of the original system is minimally affected so that reliable results can be obtained from that time point. Some examples of Linux tracing tools which use the above method are LTTng and K42 of IBM.

In the execution file operation tracing method, software measurement is achieved by generating a trap by inserting a breakpoint into an execution file and executing the execution file. Some tools for performing software measurement using breakpoints such as a GDB debugger are System TAP and Dtrace of Sun Co. Ltd, and Ptrace in Linux.

In the sampling method, desired information is periodically collected by using a daemon and performance counter. Information of a symbol which is being executed may be extracted by generating a collection demonstration, or information such as a command or a clock cycle may be obtained using a hardware device. A representative example of using such a method is Oprofile, which is a profiler that collects and analyzes command information via execution of the kernel area using both the daemon and the performance counter.

In order to measure the performance of a current application, a method of linking a dynamic library for performance measurement to a binary file and a method of inserting a performance measurement function by modifying the current application have been widely used.

The method of linking a dynamic library for performance measurement to the binary file may measure the performance of the current application without modifying the current application, but as the performance operation is added, the operation method of the current application is significantly changed, and thus, it is difficult to obtain accurate performance data due to contamination of the data cache.

The method of adding the performance measurement function by modifying the application requires fewer operation changes of the application than the dynamic library scheme, but in this case too it is difficult to obtain accurate performance data due to the operation of the function for performance measurement and the use of data.

### SUMMARY

Exemplary embodiments provide methods and apparatuses for measuring software performance by stalling a target system on which source code is executed by a processor and a performance counter based on a performance measurement code inserted into a source code, transmitting performance data corresponding to a stalled time point when the target system and the performance counter are stalled to a host system, and measuring the software performance by resuming execution of the source code by the target system and of the performance counter while the transmitted performance data is stored.

According to an aspect of an exemplary embodiment, there is provided a method of measuring software performance including: inserting a performance measurement code into a source code; stalling a target system, on which the source code is executed by a processor, and a performance counter based on the performance measurement code; transmitting performance data, corresponding to a stalled time point when the target system and the performance counter are stalled, to a host system configured to store the performance data corresponding to the stalled time point; and resuming execution of the source code by the target system and of the performance counter while the performance data is transmitted and stored.

The inserting of the performance measurement code may be performed automatically by a compiler of the target system.

The performance measurement code may be inserted into the source code at a beginning point and at an end point of a subject function of which performance is to be measured.

In the transmitting of the performance data, the performance data may be transmitted at the stalled time point to the host system configured to store the performance data corresponding to the stalled time point in a separate storage device.

The performance data may include at least one of a program counter value and a performance counter value.

The performance data may include at least one of a number of times of calling, cycle information, a bank conflict, a bus stall, and an instruction cache miss.

The resuming execution of the source code by the target system and of the performance counter may be performed in response to the target system receiving a predetermined event from the host system.

The resuming execution of the source code by the target system and of the performance counter may be performed in response to a predetermined time needed for storing the performance data passing.

The method may further include obtaining a result of a performance measurement based on performance data at the beginning point and performance data at the end point of the subject function.

The obtaining of the result of performance measurement may include: determining whether the subject function of which performance is to be measured is a terminal function; and obtaining a result of a performance measurement based on a difference value between the performance data at the end point of the subject function and the performance data at the beginning point of the subject function in response to the subject function being the terminal function, and obtaining a result of a performance measurement by deducting a result value of a performance measurement of called functions (callees) of the subject function from the difference value between the performance data at the end point of the subject function and the performance data at the beginning point of the subject function in response to the subject function not being the terminal function, wherein the result value of the performance measurement of the called functions is obtained based on the difference value between the performance data of the end point and the performance data at the beginning point of each of the called functions.

The method may further include displaying the obtained result of the performance measurement on a display.

The performance measurement code may be a function.

The performance measurement code may be a command that is not a function.

According to an aspect of another exemplary embodiment, there is provided a non-transitory computer-readable medium storing a program causing a computer to execute the above-described method of measuring the software performance.

According to an aspect of yet another exemplary embodiment, there is provided an apparatus for measuring software performance including: a controller configured to stall a target system, on which a source code is executed by a processor, and a performance counter based on a performance measurement code which has been inserted into the source code; a transmission reception unit configured to transmit performance data, corresponding to a stalled time point when the target system and the performance counter are stalled, to a host system configured to store performance data corresponding to the stalled time point; and an execution unit configured to resume execution of the source code by the target system and of the performance counter while the performance data is transmitted and stored.

A compiler of the target system may be configured to automatically insert the performance measurement code.

The performance measurement code may be inserted into the source code at a beginning point and at an end point of a subject function of which performance is to be measured.

The transceiver may be configured to transmit the performance data corresponding to the stalled time point to the host system in order to store the performance data at the stalled time point in a separate storage device.

The performance data may include at least one of a program counter value and a performance counter value.

The performance data may include at least one of a number of times of calling, cycle information, a bank conflict, a bus stall, and an instruction cache miss.

In response to the transceiver receiving a predetermined event from the host system, the execution unit may be configured to resume execution of the source code by the target system and of the performance counter.

In response to a predetermined time needed for storing the performance data passing, the execution unit may be configured to automatically resume execution of the source code by the target system and of the performance counter.

The apparatus may further include a calculation unit configured to obtain a result of a performance measurement based on the performance data at the beginning point and the performance data at the end point of the subject function.

The calculation unit may be configured to determine whether the subject function is a terminal function, and may be configured to obtain a result of a performance measurement based on a difference value between the performance data at the end point of the subject function and the performance data at the beginning point of the subject function in response to the subject function being the terminal function, and is configured to obtain a result of a performance measurement by deducting a result value of a performance measurement of called functions (callees) of the subject function from the difference value between the performance data at the end point of the subject function and the performance data at the beginning point of the subject function in response to the subject function not being the terminal function, wherein the calculation unit is configured to obtain the result value of the performance measurement of the called functions based on the difference value between the performance data of the end point and the performance data at the beginning point of each of the called functions.

The apparatus may further include a display configured to display the obtained result of performance measurement.

The performance measurement code may be a function.

The performance measurement code may be a command that is not a function.

### BRIEF DESCRIPTION OF THE DRAWINGS

These and/or other aspects will become apparent and more readily appreciated from the following description of the exemplary embodiments, taken in conjunction with the accompanying drawings in which:

FIG. 1 is a flowchart illustrating a method of measuring software performance, according to an exemplary embodiment;

FIG. 2 is a conceptual diagram of software performance measurement, according to an exemplary embodiment;

FIG. 3 is a diagram illustrating a system of a software performance measurement apparatus, according to an exemplary embodiment;

FIG. 4 illustrates insertion of a performance measurement code, according to an exemplary embodiment;

FIG. 5 is a flowchart illustrating a method of calculating a result of software performance measurement, according to an exemplary embodiment;

FIG. 6 illustrates a terminal function according to an exemplary embodiment;

FIG. 7 illustrates an output of a result of performance measurement for each function, according to an exemplary embodiment; and

FIG. 8 is a block diagram of a software performance measurement apparatus, according to an exemplary embodiment.

### DETAILED DESCRIPTION

Reference will now be made in detail to exemplary embodiments, examples of which are illustrated in the accompanying drawings, wherein like reference numerals refer to like elements throughout. In this regard, the exemplary embodiments may have different forms and should not be construed as being limited to the descriptions set forth herein. Accordingly, the exemplary embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

Throughout the present specification, a “target system” may refer to a system that executes developed software and which is an object of performance analysis. In the present specification, the target system may be used as a concept including a target processor and a target core.

Throughout the present specification, a “host system” may refer to a general-purpose computer system used for measuring the performance of software executed in the target system. In the present specification, the host system may be used as a concept including a host processor and a host core.

Throughout the present specification, “software” may be used as a concept including internal-type software, semi-internal-type software, and independent-type software.

Throughout the present specification, a “terminal function” may refer to a function that does not include a called function (callee).

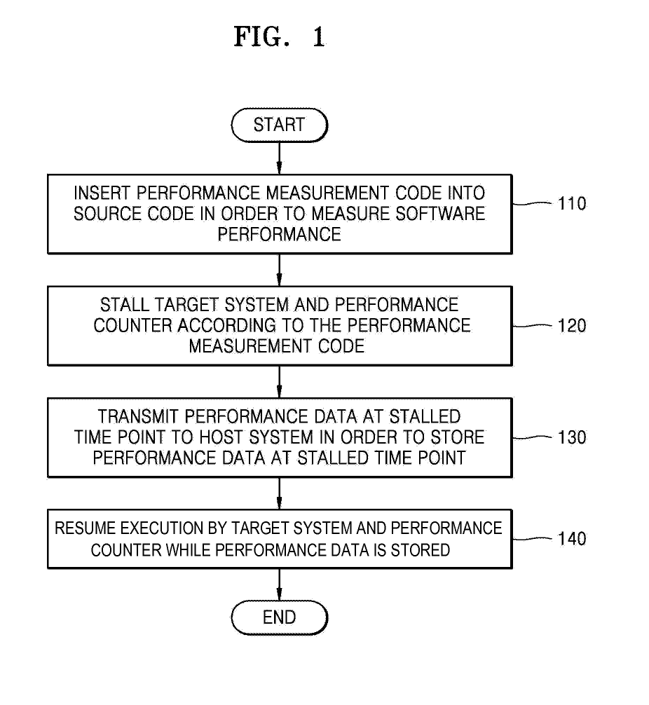

FIG. 1 is a flowchart illustrating a method of measuring software performance, according to an exemplary embodiment.

In operation 110, the apparatus may insert a performance measurement code into a source code in order to measure the performance of software.

The performance measurement code according to an exemplary embodiment may be inserted into a function within the source code in order to measure the performance of software. The performance measurement code may read performance data at a stopped time point by stalling the target system and performance counter so as to prevent distortion of data generated while measuring the data.

According to an exemplary embodiment, the performance measurement code may be inserted into the source file based on the user's input.

According to another exemplary embodiment, the performance measurement code may be automatically inserted into the source file. For example, in a compile operation, a compiler of the target system may automatically insert the performance measurement code into a source file. As the performance measurement code is automatically inserted, the user may conveniently perform performance analysis of software without the user's direct modification of the source code.

According to another exemplary embodiment, the performance measurement code may be respectively inserted at the beginning and end of a subject function for measurement within the source code.

In operation 120, the apparatus may stall the target system and performance counter based on the performance measurement code.

The execution of the performance counter according to an exemplary embodiment may be stopped according to a command of the performance measurement code. That is, existing performance counters cause distortion of the performance data because the operation of the counter does not stop even when the execution of the target system is stopped. According to an exemplary embodiment, the performance counter is a stallable performance counter, and thus, distortion of the performance data may be prevented because the operation of the counter is also stopped while the execution of the target system is stopped based on the performance measurement code.

In operation 130, the apparatus may transmit the performance data to the host system at the stopped time point in order to store the performance data at the stopped time point.

The performance data according to an exemplary embodiment may include at least one of a program counter value and a performance counter value.

The performance data according to an exemplary embodiment may include at least one of the number of times of calling, cycle information, a memory bank conflict, a bus stall, and an instruction cache miss.

According to an exemplary embodiment, the performance data at the stopped time point may be stored in the storage of the host system.

According to another exemplary embodiment, the performance data at the stopped time point may be stored in a separate storage device. Some examples of the separate storage device are a floppy disk drive, a hard disk drive, a magnetic drum, a magnetic tape, an optical disk (CD), and a flash memory. The separate storage device may be placed in an external system. If the performance data at the stopped time point is transmitted to the host system, the host system may retransmit the performance data to a separate storage device. The transmitted performance data may be stored in a separate storage device.

In operation 140, the apparatus may resume execution by the target system and the performance counter as the performance data is stored.

According to another exemplary embodiment, as a certain event is received by the target system from the host system, the apparatus may resume execution by the target system and the performance counter. The host system may store the performance data and then transmit the event for resuming execution by the target system and the performance counter to the target system. The event may include writing the performance data value in a register and sending a signal to the target system, but the exemplary embodiments are not limited to these examples.

According to another exemplary embodiment, after a predetermined time needed for storing performance data passes, the apparatus may automatically resume execution by the target system and performance counter. The time is set according to the environment or is set as a default value sufficient for storing the performance data, but the exemplary embodiments are not limited to the examples.

In an exemplary embodiment, the target system may be included in the device such as the host system. For example, the target system and the host system may be a target core and a host core which are included in the apparatus such as the target system and the host system. As another example, the target system and the host system may be a target processor and a host processor within the same apparatus.

In another exemplary embodiment, the target system may be a system which is included in an apparatus other than the host system.

For example, when applied to performance measurement of embedded software in a cross development environment, the target system may be an embedded system and the host system may be a general-purpose computer system.

The embedded system refers to a computer system where software for operating the system is embedded in hardware and which has a special function. Generally, the embedded system may refer to a computer system which is embedded in a device or apparatus having a special function with a special purpose unlike a general-purpose computer system such as a desktop PC. For example, the embedded system may include a computer system embedded in mobile devices such as a mobile phone, a portable digital assistant (PDA), and a web pad, or a computer system embedded in electronic appliances such as a digital TV and an Internet refrigerator, but the exemplary embodiments are not limited to the examples.

The embedded system does not require resources such as a high-performance and high-capacity CPU and memory, and thus, the embedded system has insufficient resources and performance when compared with the general-purpose computer system. As such, the development of the embedded software which is performed in the embedded system may be performed in a general-purpose computer system with superior performance. According to an exemplary embodiment, the host system may be a general-purpose computer system, and the target system may be an embedded system.

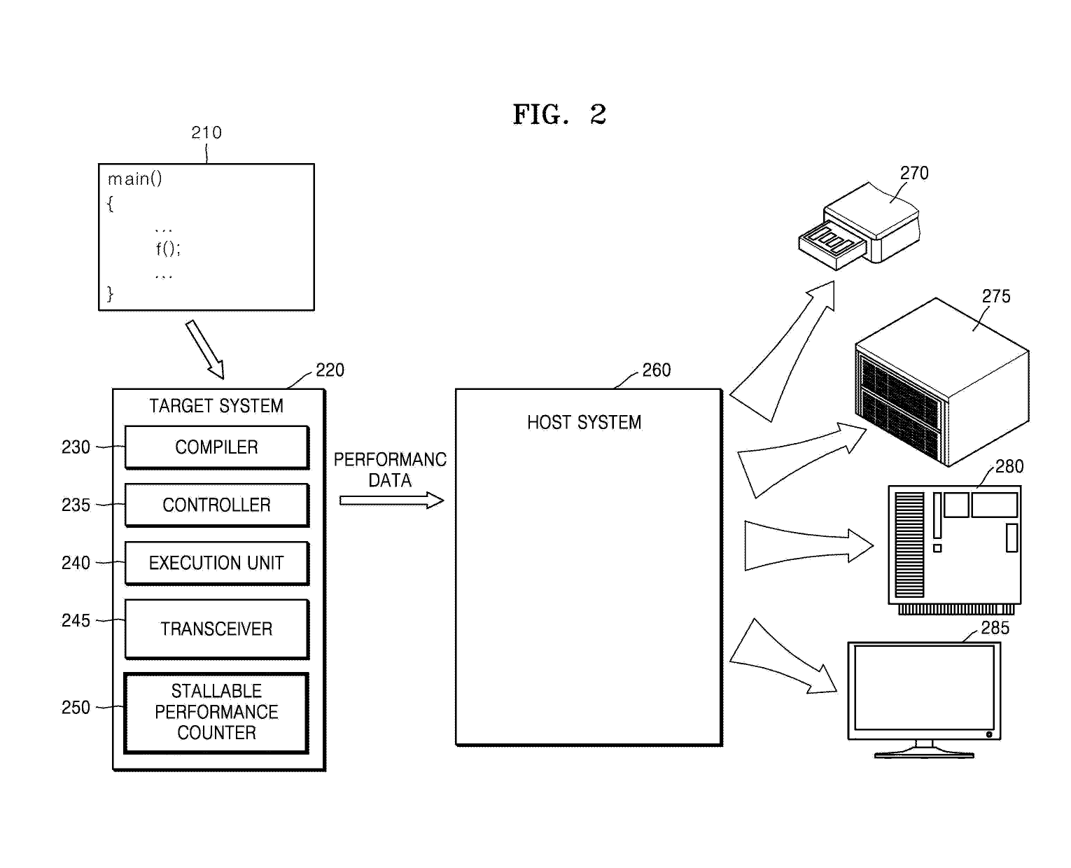

FIG. 2 is a conceptual diagram of software performance measurement, according to an exemplary embodiment.

As illustrated in FIG. 2, the target system 220 according to an exemplary embodiment may include a compiler 230, a controller 235, an execution unit 240, a transceiver 245, and a stallable performance counter 250. However, not all these components are essential. The target system 220 may be implemented by using more or fewer components, which will be described in detail later.

The host system 260 according to an exemplary embodiment may store performance data, which is read from the target system 220, in a separate storage device 270. The separate storage device 270 may include a floppy disk drive, a hard disk drive, a magnetic drum, a magnetic tape, an optical disk (CD), and a flash memory, but the exemplary embodiments are not limited to such examples. The separate storage device 270 may be placed in an external system. If the performance data at the stopped time point is transmitted to the host system, the host system may then transmit the performance data to a separate storage device. The transmitted performance data may be stored in the separate storage device.

The host system 260 according to an exemplary embodiment may upload the performance data to the server 275. The server 275 may include a database (DB) server and a web server such as a cloud.

The host system 260 according to an exemplary embodiment may transmit the performance data to a separate performance analysis device 280. That is, the collection of the performance data may be performed in the host system 260, and the analysis of the performance data may be performed in the separate performance analysis device 280. The separate performance analysis device 280 may include a separate processor and a separate computing device.

The host system 260 according to an exemplary embodiment may display the performance data on a separate display device 285. For example, the host system 260 may transmit the performance data to a separate display device 285 and display the performance data on the separate display device 285.

In another exemplary embodiment, the host system 260 may store transmitted performance data and produce the result of the performance measurement so as to display the produced measurement result on the separate display device 285.

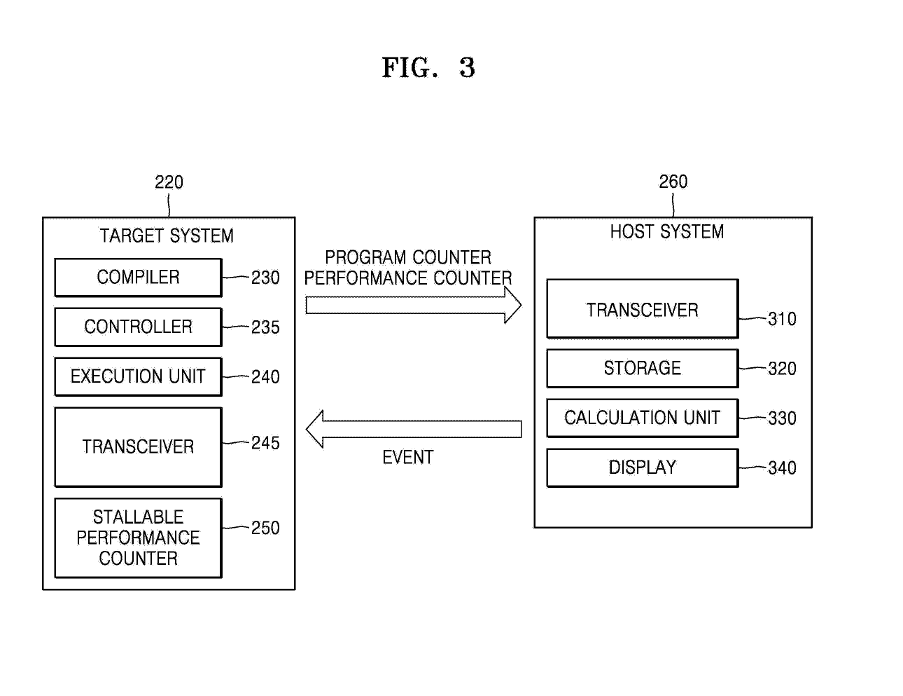

FIG. 3 is a diagram illustrating the system of a software performance measurement apparatus, according to an exemplary embodiment.

As illustrated in FIG. 3, a target system 220 according to an exemplary embodiment may include a compiler 230, a controller 235, an execution unit 240, a transceiver 245, and a stallable performance counter 250. However, not all such components are essential components. The target system 220 may be implemented by more or fewer components.

The compiler 230 according to an exemplary embodiment may automatically insert the performance measurement code into the source file. As the performance measurement code is automatically inserted, the user may conveniently perform performance analysis of software without the user's direct modification of the source code.

The controller 235 according to an exemplary embodiment may stop the target system and the performance counter 250 based on the performance measurement code inserted in the source code.

The execution unit 240 according to an exemplary embodiment may resume execution by the target system and the performance counter 250 as the performance data is transmitted and stored.

According to an exemplary embodiment, the execution unit 240 may resume execution by the target system and the performance counter 250 as a certain event is received from the host system 260.

According to another exemplary embodiment, after a predetermined time needed for storing the performance data passes, the execution unit 240 may automatically resume execution by the target system and the performance counter 250.

The transceiver 245 according to an exemplary embodiment may transmit the performance data at the stopped time point to the host system in order to store the performance data at the stopped time point. Furthermore, a certain event for resuming execution by the target system 220 and the performance counter 250 may be received from the host system.

The stallable performance counter 250 according to an exemplary embodiment may be stopped as in the target system 220 according to the command of the performance measurement code. That is, a conventional performance counter causes distortion of the performance data because the operation of the counter does not stop even when the execution of a target system is stopped. According to an exemplary embodiment, the performance counter 250 includes a stallable performance counter, and may prevent distortion of the performance data because the operation of the counter is also stopped when the execution of the target system 220 is stopped based on the performance measurement code.

As illustrated in FIG. 3, the host system 260 according to an exemplary embodiment may include a transceiver 310, a storage 320, a calculation unit 330, and a display 340. However, not all these components are essential. The host system 260 may be implemented by using more or fewer components.

The transceiver 310 according to an exemplary embodiment may receive performance data from the target system 220. Furthermore, the transceiver 310 may transmit a predetermined event for resuming execution by the performance counter 250 to the target system 220.

The storage 320 according to an exemplary embodiment may read and store the performance data at the time point when the target system 220 and the performance counter 250 are stopped. However, in another exemplary embodiment, the storage 320 may be included in a separate storage device outside the host system 260.

The calculation unit 330 according to an exemplary embodiment may generate the result of the performance measurement based on the performance data. For example, the calculation unit 330 may generate the result of the performance measurement based on the performance data at the start time of the subject function and the performance data at the end time of the subject function. In another exemplary embodiment, the calculation unit 330 may be included in a separate analysis device outside the host system 260.

The display 340 according to an exemplary embodiment may display at least one of the performance data, the result of performance measurement, and the performance analysis result. However, in another exemplary embodiment, the display 340 may be included in a separate output device outside the host system 260.

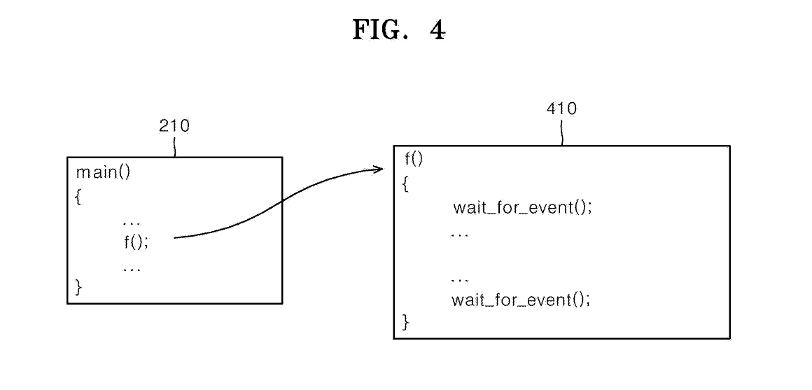

FIG. 4 illustrates insertion of a performance measurement code, according to an exemplary embodiment.

FIG. 4 illustrates an original source code 210 and a code 410 where the performance measurement code has been inserted into the function of the source code.

In an exemplary embodiment, a performance measurement code may be inserted into the source code 210.

According to an exemplary embodiment, the performance measurement code may be written as a function “wait-for-event( )” since the target system and the performance counter are stalled until a certain event is received from the host system. However, the performance measurement code according to an exemplary embodiment does not necessarily need to be in a function form and may include other types of commands.

According to another exemplary embodiment, the performance measurement code may be inserted into the source code 210 at the beginning point and the end point of the subject function of which performance is to be measured. Furthermore, the performance measurement code may be respectively inserted at the beginning point and the end point of the called function (callee) of the subject function.

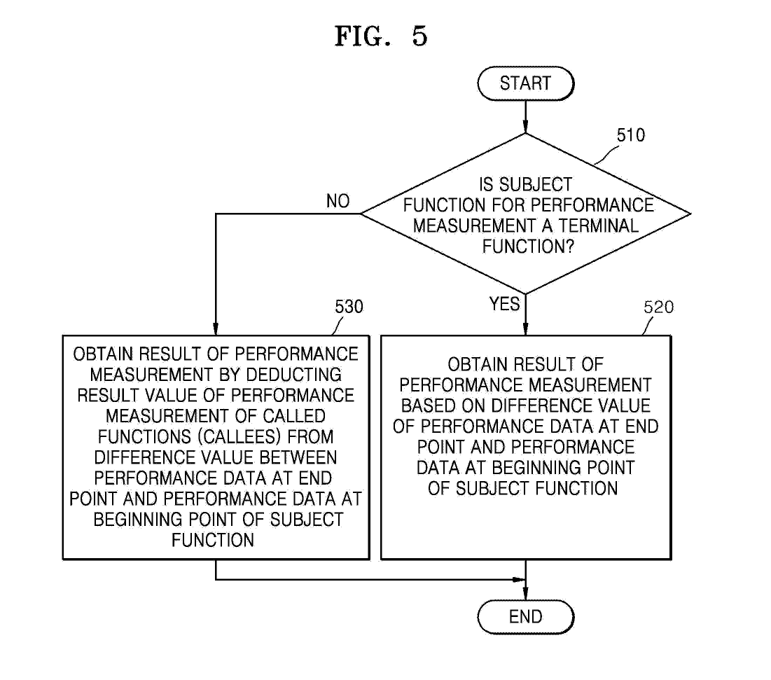

FIG. 5 is a flowchart illustrating a method of calculating the result of software performance measurement, according to an exemplary embodiment.

In operation 510, the apparatus determines whether the subject function of which performance is to be measured is a terminal function.

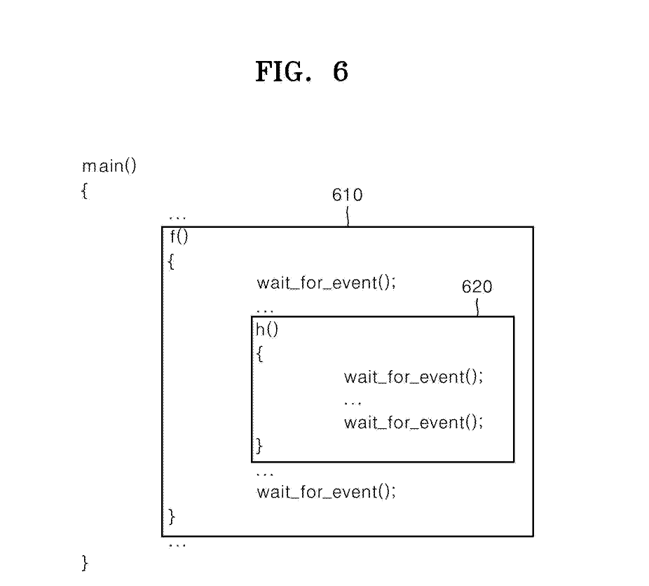

The method of determining whether the function is a terminal function will be described in detail with reference to FIG. 6.

As a result of the determination, if the subject function is the terminal function, operation 520 is performed, and if the subject function is not the terminal function, operation 530 is performed.

In operation 520, the apparatus may generate the result of performance measurement based on the difference value between the performance data at the beginning point of the subject function and the performance data at the end point of the subject function.

For example, in order to calculate the performance time for each function, the equation as in equation 1 below may be used.

Performance time=the counter value at the end point of a function−the counter value at the beginning point of the function Equation 1

In operation 530, the apparatus may obtain the result of performance analysis by deducting the result value of performance measurement of called functions (callees) of the subject function from the difference value between the performance data at the beginning point of the subject function and the performance data at the end point of the subject function.

For example, in order to measure the performance time for each function, equations 2 and 3 below may be used.

Performance time=the counter value at the beginning point of the subject function−the counter value at the end point of the subject function−the sum of performance times of called functions (callees) Equation 2

Performance time of called function (callee)=the counter value at the end point of the called function−the counter value at the beginning point of the called function (when the called function is a terminal function) Equation 3

FIG. 6 illustrates a terminal function according to an embodiment of the present invention.

Referring to FIG. 6, f( ) according to an exemplary embodiment represents a calling function (caller) 610, and h( ) represents a called function (callee) 620.

The terminal function may refer to a function which does not include a called function within a function, such as h( ) according to an exemplary embodiment. Hence, the performance of the terminal function may be measured by calculating the difference between the performance data at the end point of the function and the performance data at the beginning point of the function.

The f( ) according to an exemplary embodiment does not correspond to the terminal function, and thus, the result of performance analysis may be obtained by deducting the result values of performance measurement of called functions (callees) from the difference value between the performance data at the end point of the function and the performance data at the beginning point of the function.

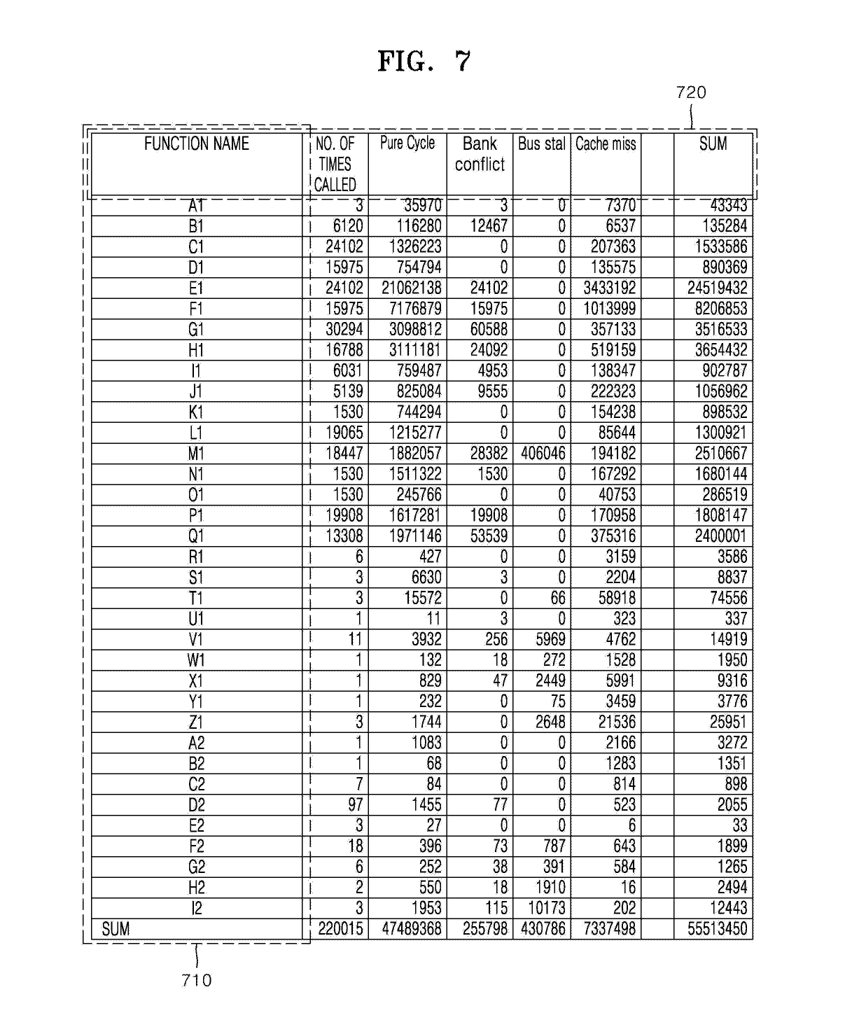

FIG. 7 illustrates an output of the result of performance measurement for each subject function, according to an exemplary embodiment.

As illustrated in FIG. 7, according to an exemplary embodiment, a vertical axis 710 represents subject functions, and a horizontal axis 720 represents the result value of performance measurement for each subject function. For example, arbitrary function names such as “A1, B1, C1, . . . , A2, B2, C2, . . . ” are illustrated in the vertical axis 710.

The apparatus may measure the performance of each subject function, according to an exemplary embodiment.

The measured performance may include the number of times of calling, cycle information, a bank conflict, a bus stall, and an instruction cache miss.

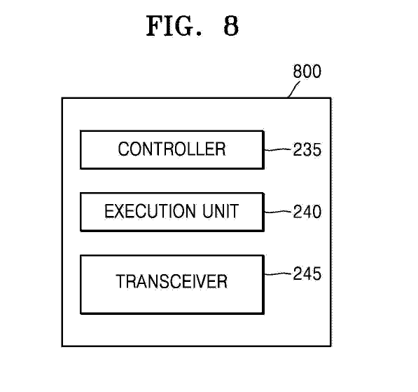

FIG. 8 is a block diagram of a software performance measurement apparatus, according to an exemplary embodiment.

As illustrated in FIG. 8, the software performance measurement apparatus 800 according to an exemplary embodiment includes a controller 235, an execution unit 240, and a transceiver 245.

The controller 235 may control the target system and the performance counter 250 to stop them based on the performance measurement code inserted in the source code.

The execution unit 240 may resume execution by the target system and the performance counter 250 as the performance data is transmitted and stored.

According to an exemplary embodiment, the execution unit 240 may resume execution by the target system and the performance counter 250 as a certain event is received from the host system 260.

According to another exemplary embodiment, the execution unit 240 may automatically resume execution by the target system and the performance counter 250 after a predetermined time needed for storing the performance data passes.

The transceiver 245 may transmit performance data at the stopped point to the host system in order to store the performance data at the stopped point. Furthermore, a predetermined event for resuming execution by the target system 220 and the performance counter 250 may be received from the host system.

As described above, according to the one or more of the above exemplary embodiments, the software performance may be measured with high accuracy by minimizing the distortion of the performance data by using the performance counter which may be stopped.

Furthermore, as the performance measurement code is inserted by a compiler, the developer may conveniently measure the software performance without directly modifying the source code.

In addition, other exemplary embodiments of the present invention can also be implemented through computer readable code/instructions in/on a medium, e.g., a computer readable medium, to control at least one processing element to implement any above described embodiment. The medium can correspond to any medium/media permitting the storage and/or transmission of the computer readable code.

The computer readable code can be recorded/transferred on a medium in a variety of ways, with examples of the medium including recording media, such as magnetic storage media (e.g., ROM, floppy disks, hard disks, etc.) and optical recording media (e.g., CD-ROMs, or DVDs), and transmission media such as Internet transmission media. Thus, the medium may be such a defined and measurable structure including or carrying a signal or information, such as a device carrying a bitstream according to one or more exemplary embodiments. The media may also be a distributed network, so that the computer readable code is stored/transferred and executed in a distributed fashion. Furthermore, the processing element may include a processor or a computer processor, and processing elements may be distributed and/or included in a single device.

It should be understood that the exemplary embodiments should be considered in a descriptive sense only and not for purposes of limitation. Descriptions of features or aspects within each embodiment should typically be considered as available for other similar features or aspects in other embodiments.

While one or more exemplary embodiments have been described with reference to the figures, it will be understood by those of ordinary skill in the art that various changes in form and details may be made therein without departing from the spirit and scope of the inventive concept as defined by the following claims.

What is claimed is:

1. A method of measuring software performance, the method comprising:
inserting a performance measurement code into a source code;
stalling a target system, on which the source code is executed by a processor, and a performance counter based on the performance measurement code;
transmitting performance data, corresponding to a stalled time point when the target system and the performance counter are stalled, to a host system configured to store the performance data corresponding to the stalled time point; and
resuming execution of the source code by the target system and of the performance counter while the performance data is transmitted and stored.

2. The method of claim 1, wherein the inserting of the performance measurement code is performed automatically by a compiler of the target system.

3. The method of claim 1, wherein the performance measurement code is inserted into the source code at a beginning point and at an end point of a subject function of which performance is to be measured.

4. The method of claim 1, wherein in the transmitting of the performance data, the performance data is transmitted at the stalled time point to the host system configured to store the performance data corresponding to the stalled time point in a separate storage device.

5. The method of claim 1, wherein the performance data includes at least one of a program counter value and a performance counter value.

6. The method of claim 1, wherein the performance data includes at least one of a number of times of calling, cycle information, a bank conflict, a bus stall, and an instruction cache miss.

7. The method of claim 1, wherein the resuming execution of the source code by the target system and of the performance counter is performed in response to the target system receiving a predetermined event from the host system.

8. The method of claim 1, wherein the resuming execution of the source code by the target system and of the performance counter is performed in response to a predetermined time needed for storing the performance data passing.

9. The method of claim 3, further comprising:
obtaining a result of a performance measurement based on performance data at the beginning point and performance data at the end point of the subject function.

10. The method of claim 9, wherein the obtaining of the result of the performance measurement comprises:
determining whether the subject function of which performance is to be measured is a terminal function; and
obtaining a result of a performance measurement based on a difference value between the performance data at the end point of the subject function and the performance data at the beginning point of the subject function in response to the subject function being the terminal function, and obtaining a result of a performance measurement by deducting a result value of a performance measurement of called functions of the subject function from the difference value between the performance data at the end point of the subject function and the performance data at the beginning point of the subject function in response to the subject function not being the terminal function,
wherein the result value of the performance measurement of the called functions is obtained based on the difference value between the performance data of the end point and the performance data at the beginning point of each of the called functions.

11. The method of claim 9, further comprising:
displaying the obtained result of the performance measurement on a display.

12. The method of claim 1, wherein the performance measurement code is a function.

13. The method of claim 1, wherein the performance measurement code is a command that is not a function.

14. A non-transitory computer-readable medium storing a program causing a computer to execute a method of measuring software performance, the method comprising:
inserting a performance measurement code into a source code;
stalling a target system, on which the source code is executed by a processor, and a performance counter based on the performance measurement code;
transmitting performance data, corresponding to a stalled time point when the target system and the performance counter are stalled, to a host system configured to store the performance data corresponding to the stalled time point; and
resuming execution of the source code by the target system and of the performance counter while the performance data is transmitted and stored.

15. An apparatus for measuring software performance, the apparatus comprising:
a controller configured to stall a target system, on which a source code is executed by a processor, and a performance counter based on a performance measurement code which has been inserted into the source code;
a transceiver configured to transmit performance data, corresponding to a stalled time point when the target system and the performance counter are stalled, to a host system configured to store performance data corresponding to the stalled time point; and
an execution unit configured to resume execution of the source code by the target system and of the performance counter while the performance data is transmitted and stored.

16. The apparatus of claim 15, wherein the performance measurement code is inserted into the source code at a beginning point and at an end point of a subject function of which performance is to be measured.

17. The apparatus of claim 15, wherein the transceiver is configured to transmit the performance data corresponding to the stalled time point to the host system in order to store the performance data at the stalled time point in a separate storage device.

18. The apparatus of claim 15, wherein in response to the transceiver receiving a predetermined event from the host system, the execution unit is configured to resume execution of the source code by the target system and of the performance counter.

19. The apparatus of claim 16, further comprising:
a calculation unit configured to obtain a result of a performance measurement based on the performance data at the beginning point and the performance data at the end point of the subject function.

20. The apparatus of claim 19, wherein the calculation unit:
is configured to determine whether the subject function is a terminal function; and
is configured to obtain a result of a performance measurement based on a difference value between the performance data at the end point of the subject function and the performance data at the beginning point of the subject function in response to the subject function being the terminal function, and is configured to obtain a result of a performance measurement by deducting a result value of a performance measurement of called functions of the subject function from the difference value between the performance data at the end point of the subject function and the performance data at the beginning point of the subject function in response to the subject function not being the terminal function,
wherein the calculation unit is configured to obtain the result value of the performance measurement of the called functions based on the difference value between the performance data of the end point and the performance data at the beginning point of each of the called functions.
